(19) United States
(12) Patent Application Publication
(10) Pub. No.: US 2014/0097310 A1
(43) Pub. Date: Apr. 10, 2014

(54) DECORATIVE ICE STRUCTURES, METHODS, AND PRODUCTION EQUIPMENT

(71) Applicant: Minnehaha Group, LLC, d/b/a Wintercraft, Minneapolis, MN (US)

(72) Inventors: Jennifer A.S. Hedberg, Minneapolis, MN (US); Thomas W.S. Hedberg, Minneapolis, MN (US)

(21) Appl. No.: 13/975,026

(22) Filed: Aug. 23, 2013

Related U.S. Application Data
(60) Provisional application No. 61/692,544, filed on Aug. 23, 2012.

(51) Int. Cl. F16M 11/04

(52) U.S. Cl. CPC F16M 11/04
USPC 248/177.1

(57) ABSTRACT

The present invention is directed to methods, materials, and devices for making and displaying globe ice lanterns and other ice structures. In a first implementation of the invention, an ice globe is produced. The ice globe can be produced with an insulating base that prevents the bottom of the ice globe from freezing solid.

### FIELD OF THE INVENTION

The present invention is directed to decorative ice structures, methods of making decorative ice structures, devices and equipment for producing the decorative ice structures, and to structures for holding and displaying ice structures.

### BACKGROUND OF THE INVENTION

Decorative ice structures are well known, and have been created for many years. For example, carved ice structures are often used at parties and special meals to create attractive and interesting centerpieces. Some ice structures are cast in molds, as opposed to being carved from solid blocks of ice.

It is often desirable to include candles or other lights integrated with the ice structures. For example, it can be quite attractive to illuminate a centerpiece or a winter walkway with a combination of ice structures and candles. One way of accomplishing such illumination is to partially freeze buckets or balloons filled with water to form an ice shell, removing the ice shell from the bucket or balloon, and then positioning a candle within the interior of the ice shell.

Although existing processes and materials for forming ice structures, including ice shells containing candles are suitable for many applications, the processes and materials would be improved if they allowed for easier, more consistent production of ice structures, and for a wider variety of ice structures to be created.

In addition to the production of ice structures, a need exists for improved options for displaying ice structures. In particular, a need exists for stands that allow for attractive display of ice structures, especially ice structures containing candles, and which allow for capture of water formed by the gradual melting of the ice structure.

### SUMMARY OF THE INVENTION

The present invention is directed, in part, to methods, materials, and devices for making and displaying globe ice lanterns and other ice structures.

In a first implementation of the invention, an ice globe is produced. To make the ice globe, a balloon is filled with water (such as tap water) by stretching the balloon's mouth around a water faucet head to form a seal. The balloon is held tightly in place with thumb and forefinger as it fills with water to desired size. Next, a clip is placed around the balloon neck, often accompanied with a twist of the balloon neck so as to seal the balloon. The balloon is thereby sealed, and can be placed in a base for freezing. The filled balloon will comfortably rest in the base. The water filled balloon and base is then placed in a freezing environment, such as on the ground in a mostly shaded area. It is preferable if average day/night temp is below 20° F./−7° C. Alternatively, in any climate the water filled balloon can be placed in a freezer. In some embodiments the balloon is clear or transparent.

To keep the bottom of the ice globe from freezing, it can be appropriate to place the balloon and base on an insulating disk. The insulating disk keeps the bottom of the balloon from freezing as quickly and completely as other parts of the balloon, which maintains the bottom of the balloon in an open configuration that allows for placement on a stand and space for a candle or other source of illumination. In some implementations it is possible to use an insulated freezing base.

Generally it is necessary to check on the balloon occasionally to confirm it is freezing, but has not frozen solid. It is possible to check to see if a shell of ice is forming by firmly pushing on the balloon after about 14 to 18 hours for a small globe, or 24 to 30 hours for a larger globe. Typically the same size of balloon can produce either small or larger globes. When a shell of ice forms, lift the balloon off the base and feel the unfrozen bottom. If the bottom is completely unfrozen, the globe will typically have thin walls. If the bottom is slushy and/or starting to freeze over, the result will be thicker walls on the ice globe.

If more thickness is desired, continue freezing and re-check occasionally, such as in 6 to 8 hours. Ice thickness varies with freezing time, volume of water, and temperature. After a desired level of freezing, cut the balloon from the ice globe in a sink or outside where excess water can run out of the interior cavity which has formed.

Next, typically a chimney hole is created in the top of the ice globe by placing it over a candle with plenty of air flow from underneath. In the alternative, a cordless drill can be used to create a chimney using a large drill bit. It is recommended that this option be completed by an adult wearing safety glasses. If the globe will be illuminated by an LED or similar light, a chimney hole is generally not necessary.

Finally, place a candle on a nonflammable surface and light. Place the ice globe over the candle with chimney at top. Adjust the bottom of the globe to allow for needed air flow.

This ice globe can be displayed on a display that allows for air flow to the candle, while still capturing water from melted ice. In an example implementation, an ice structure display stand comprises a platform configured to retain an ice structure; a riser secured to the bottom of the platform; and a bowl retaining the riser. Optionally the platform comprises a central area for retaining a light source. In some implementations the central area for retaining a light source has a diameter of less than 3 inches. In certain embodiments the central area for retaining a light source has a diameter of greater than 2 inches. Typically the central area for retaining a light source has a diameter of from 2 to 3 inches. The central area for retaining a light source can have a depression for retaining the light source.

Typically the platform comprises a plurality of openings in the platform, the plurality of openings allowing for water to pass through the platform and into the bowl while also allowing air to travel up to the light source (often a candle). Typically the plurality of openings account for at least 15 percent of the surface of the platform. Optionally the plurality of openings account for at least 25 percent of the surface of the platform. In some embodiments the plurality of openings account for at least 35 percent of the surface of the platform. In the alternative, the plurality of openings account for at least 50 percent of top surface of the platform.

The platform can be made of a variety of materials, including metal. One benefit of the use of metal is that the ice structure can readily fuse to metal surfaces, and is thereby held in place well on the metal surface. Often the platform comprises an upwardly facing perimeter lip for securing an ice structure. The platform can support an ice structure of at least 15 pounds in most embodiments, and optionally at least 25 pounds. In some implementations the platform and riser are integrally formed. Typically the platform has a diameter less than 90 percent of the diameter of the bowl; alternatively the platform has a diameter less than 70 percent of the diameter of the bowl, or in the alternative the platform has a diameter less than 50 percent of the diameter of the bowl.

Furthermore, a mesh or grid intermediate the platform and bowl can be provided, the mesh or grid configured for retaining decorative elements. For example, the mesh or grid can be configured so that stems of vegetative materials (vines, pine boughs, flower stems, etc.) can be inserted into the mesh or grid and held in place for decorative effect.

A further specific embodiment of a display stand made in accordance with the present disclosure is an ice structure display stand comprising a top platform configured to retain an ice structure, the platform comprising a recessed central area, an upwardly turned perimeter lip, and a plurality of openings through the platform intermediate the recessed central area and the upwardly turned perimeter lip; a riser, the riser secured to the underside of the top platform and comprising a top surface configured to engage a bottom surface of the top platform; a bowl, the bowl retaining the riser, wherein the bowl has a diameter at least 25 percent greater than the diameter of the top platform; and an intermediate platform located between the top platform and the bowl, the intermediate platform substantially surrounding the riser and having an external diameter greater than the platform but less than the bowl, wherein the platform has a plurality of holes of at least 0.5 inches in diameter covering at least 50 percent of the top platform

The above summary of the present invention is not intended to describe each discussed embodiment of the present invention. This is the purpose of the figures and the detailed description that follows.

### BRIEF DESCRIPTION OF THE DRAWINGS

The invention will be more fully explained with reference to the following drawings.

FIG. 1 shows an ice globe made in accordance with an implementation of the invention, the ice globe positioned on a display stand and containing a luminary candle.

FIG. 2 shows an ice globe made in accordance with an implementation of the invention, the ice globe shown without a display stand or luminary candle.

FIG. 3 shows a balloon filled with water for forming an ice globe, the balloon positioned within a base, and the base further positioned on an insulating substrate.

FIG. 4 shows a perspective view of a base for holding a water filled balloon during ice globe formation.

FIG. 5A shows a side cross sectional view of a base made in accordance with a first implementation of the invention.

FIG. 5B shows a side cross sectional view of a base made in accordance with a second implementation of the invention.

FIG. 5C shows a side cross sectional view of a base made in accordance with a third implementation of the invention.

FIG. 6A shows a first display stand made in accordance with an implementation of the invention.

FIG. 6B shows a second display stand made in accordance with an implementation of the invention.

FIG. 6C shows a third display stand made in accordance with an implementation of the invention, with an ice globe and candle positioned on the display stand.

FIG. 7 shows a mold for forming ice structures having various shapes and sides formed using a cord to shape the mold in accordance with an implementation of the invention.

FIG. 8A shows elements of an ice castle lantern mold in accordance with an implementation of the invention.

FIG. 8B shows elements of an ice castle lantern mold in accordance with an implementation of the invention.

FIG. 8C shows elements of an ice castle lantern mold in accordance with an implementation of the invention.

FIG. 9 shows an ice castle ice lantern made in accordance with an implementation of the invention.

FIG. 10A shows a mold for making an ice wreath in accordance with an implementation of the invention.

FIG. 10B shows an ice wreath made in accordance with an implementation of the invention.

FIG. 11A shows an ice glass kit made in accordance with an implementation of the invention.

FIG. 11B shows an ice glass kit made in accordance with an implementation of the invention.

FIG. 11C shows an ice glass kit made in accordance with an implementation of the invention.

FIG. 12A shows ice chimes and ice chime production mold made in accordance with an implementation of the invention.

FIG. 12B shows ice chimes and ice chime production mold made in accordance with an implementation of the invention.

FIG. 13 shows an ice chime made in accordance with an implementation of the invention.

FIG. 14 shows an easy-release bucket ice lantern made in accordance with an implementation of the invention.

FIG. 15 shows an easy-release bucket ice lantern with a collapsible center tube made in accordance with an implementation of the invention.

FIG. 16A shows an exploded view of a centerpiece unit made in accordance with an implementation of the invention.

FIG. 16B shows a centerpiece unit made in accordance with an implementation of the invention.

FIG. 17 shows a centerpiece unit with a globe ice lantern made in accordance with an implementation of the invention.

FIG. 18 shows a display pedestal made in accordance with an implementation of the invention.

FIG. 19 shows a chimney creator stand and display stand.

FIG. 20 shows an alternative platform and riser made in accordance with an implementation of the invention.

FIG. 21 shows a top view of a platform made in accordance with an implementation of the invention.

FIG. 22 shows a display assembly made in accordance with an implementation of the invention, the display assembly including an intermediate platform.

FIG. 23 shows a first process for making an ice structure wall.

FIG. 24 shows a second process for making an ice structure wall.

While principles of the invention are amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure and claims.

### DETAILED DESCRIPTION OF THE INVENTION

The present invention is directed, in part to methods, materials, and devices for making globe ice lanterns and other ice structures, as well as display systems for globe ice lanterns and other ice structures.

In an example implementation of an ice structure, an ice globe is produced. To make the ice globe, a balloon is filled with water (such as tap water) by stretching the balloon's mouth around a water faucet head to form a seal. The balloon is held tightly in place with thumb and forefinger as it fills with water to desired size. Next, a clip is placed around the balloon neck, often accompanied with a twist of the balloon neck so as to seal the balloon. The balloon is thereby sealed, and can be placed in a base for freezing. The filled balloon will comfortably rest in the base. The water filled balloon and base is then placed in a freezing environment. After freezing the balloon is removed and a chimney hole is crated in the top of the ice globe by placing it over a candle with plenty of air flow from underneath. In the alternative, a cordless drill can be used to create a chimney using a large drill bit.

In an example implementation of a display stand, an ice structure display stand comprises a platform configured to retain an ice structure. A riser is secured to the bottom of the platform. The riser is placed in a bowl. Optionally the platform comprises a central area for retaining a light source. In some implementations the central area for retaining a light source has a diameter of less than 3 inches. In certain embodiments the central area for retaining a light source has a diameter of greater than 2 inches. Typically the central area for retaining a light source has a diameter of from 2 to 3 inches. The central area for retaining a light source can have a depression for retaining the light source.

In some embodiments the platform comprises a plurality of openings extending from a top surface to a bottom surface, the plurality of openings allowing for water to pass through the platform and into the bowl. Typically the plurality of openings account for at least 15 percent of the top surface of the platform. Optionally the plurality of openings account for at least 25 percent of the top surface of the platform. In some embodiments the plurality of openings comprise at least 35 percent of the top surface of the platform. In the alternative, the plurality of openings comprise at least 50 percent of the top surface of the platform.

Often the platform comprises an upwardly facing perimeter lip for securing an ice structure. The platform can support an ice structure of at least 15 pounds in most embodiments, and optionally at least 25 pounds. In some implementations the platform and riser are integrally formed. Typically the platform has a diameter less than 75 percent of the diameter of the bowl, alternatively the platform has a diameter less than 50 percent of the diameter of the bowl.

A further specific embodiment is directed to an ice structure display stand, the stand comprising a top platform configured to retain an ice structure, the platform comprising a recessed central area, an upwardly turned perimeter lip, and a plurality of openings through the platform intermediate the recessed central area and the upwardly turned perimeter lip; a riser, the riser secured to the underside of the top platform and comprising a top surface configured to engage a bottom surface of the top platform; a bowl, the bowl retaining the riser, wherein the bowl has a diameter at least 25 percent greater than the diameter of the top platform; and an intermediate platform located between the top platform and the bowl, the intermediate platform substantially surrounding the riser and having an external diameter greater than the platform but less than the bowl, wherein the platform has a plurality of holes of at least 0.5 inches in diameter covering at least 50 percent of the top platform.

Alternative ice structures can also be created, including multi-sided ice lantern buckets, icicle castle lanterns, ice wreaths, ice chimes, etc. Some such embodiments are discussed below:

In one example, a multi-sided ice lantern bucket is used to produce the ice structure. The bucket has a series of holes around its top allowing a cord to be strong through to make various shapes: pulling the cord through two opposite holes equals oblong lantern; pulling a cord through four opposite holes equals 4-pointed star lantern; pulling a cord through eight opposite holes equals an eight-pointed star lantern; etc.

The invention is further directed to an icicle castle lantern. Trays with icicle shapes can be molded in silicone and then transferred to a mold so that they will form the perimeter of a display.

In yet another example implementation, ice wreathes are created. The ice wreathes are formed in an open pan, such as plastic, silicone, or metal. An extra tube comes from the bottom of the pan with or without a special shape to make a hole to hang the finished ice wreath. To use, the pan is filled with water plus any decorative accents and then allowed to freeze. After freezing, the mold is released and the wreath can be hung from top hole.

Another alternative embodiment includes sheets of thin ice “glass” formed from, for example, a thin sheet of ice made in a pan or flat plastic sheet. Pieces of the ice “glass” can be formed into an arrangement around a light source such as an ice lantern, a glass vase with candle, or LED lights.

In an alternative embodiment of the invention, ice chimes are created. The ice chimes can be made in a plastic, silicone or metal mold (or other suitable material). An extra tube comes from the bottom of the mold which makes a hole to hang the ice chimes. It is possible to make the chimes in multiple sizes, such as three different sizes. To produce the chimes, fill the mold with water plus any garnishes. Freeze solid or let only top few inches freeze. Release from mold and hang from top hole.

An easy-release ice lantern bucket can also be created using a multi-sided soft silicone bucket with handles. With the collapsible center tower down, the traditional method of allowing a shell of ice to form and then release is used. With the collapsible tower up, the user can allow the lantern to freeze solid and still be used because the ice lantern mold will easily peel off the ice structure.

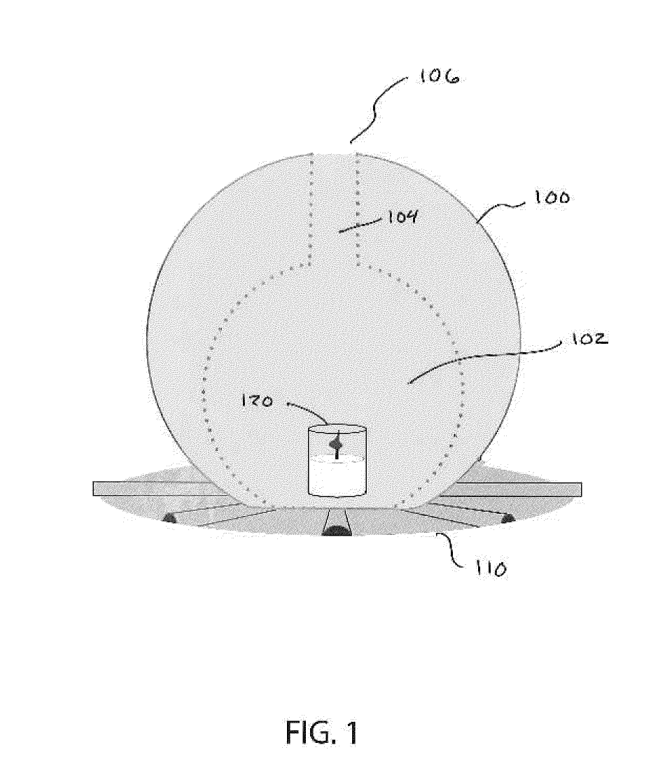

In reference first to the figures, FIG. 1 shows an ice globe 100 made in accordance with an implementation of the invention. The ice globe 100 is positioned on a display stand 110 and contains a luminary candle 120. The ice globe 100 includes an open interior 102, having a chimney 104 extending out the top 106 of globe 100. It will be understood that generally the ice globe 100 can be of varying shapes, but will generally be spherical or nearly spherical.

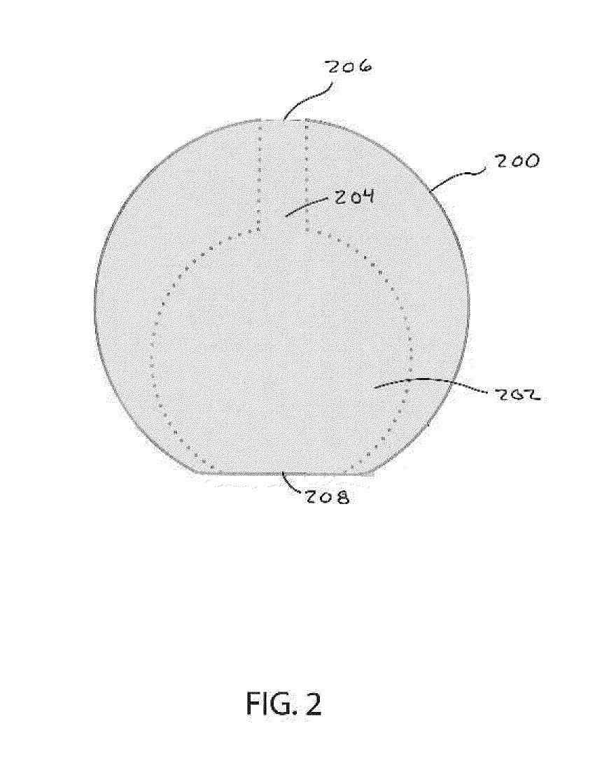

FIG. 2 shows an ice globe 200 made in accordance with an implementation of the invention, the ice globe 200 is shown without a display stand or luminary candle. The ice globe 200 includes an interior 202 having a chimney 204 extending out the top 206. The bottom 208 of the ice globe 200 has a generally flat shape, so as to better fit on a stand.

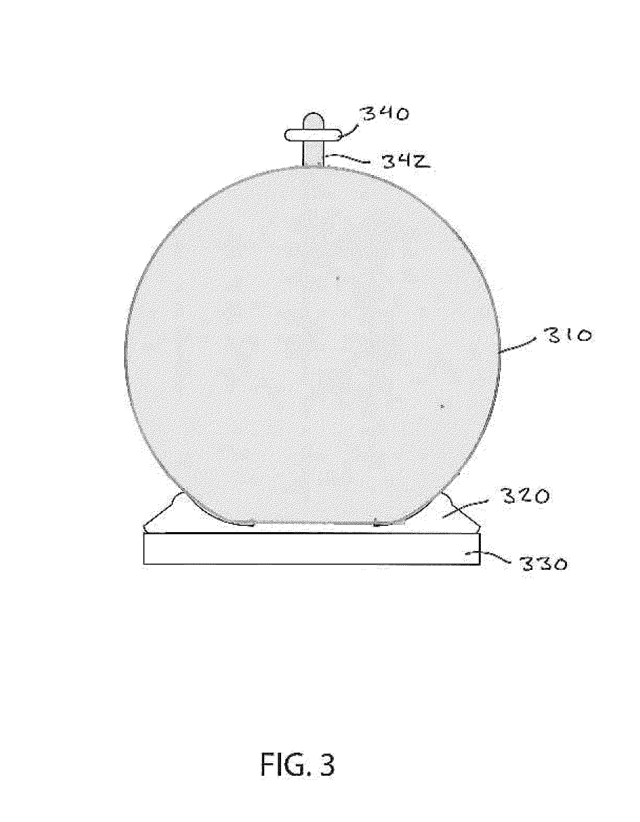

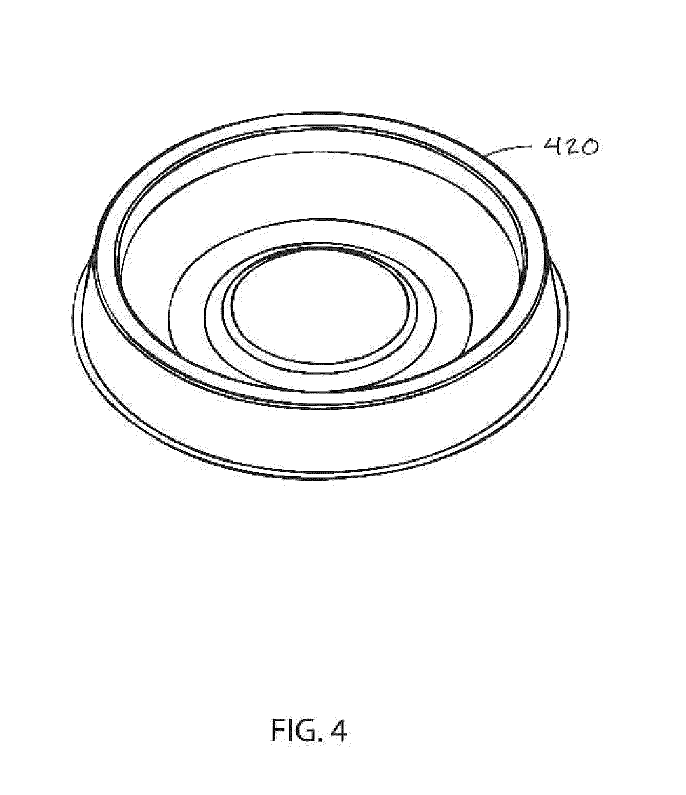

FIG. 3 shows a balloon 310 filled with water for forming an ice globe, the balloon 310 is positioned on a base 320, and the base 320 is further positioned on an insulating substrate 330. The base 320 helps hold the balloon 310 and gives the bottom of the balloon shape. FIG. 4 shows a perspective view of a base 420 for holding a water filled balloon during ice globe formation.

To make the ice globe, a balloon 310 is filled with water (such as tap water) by stretching the mouth of the balloon around a water faucet head to form a seal. The balloon 310 is held tightly in place with thumb and forefinger as it fills with water to desired size. Next, a clip 340 is placed around the balloon neck 342, often accompanied with a twist of the balloon neck 342 so as to seal the balloon 310. The balloon 310 is thereby sealed, and can be placed in a base 320 or 420. The filled balloon will comfortably rest in the base. The water filled balloon and base is then placed in a freezing environment, such as on the ground in a mostly shaded area (best if average day/night temp is below 20° F./−7° C.). In the alternative, the water filled balloon can be placed in a freezer. In some embodiments the balloon is clear or transparent.

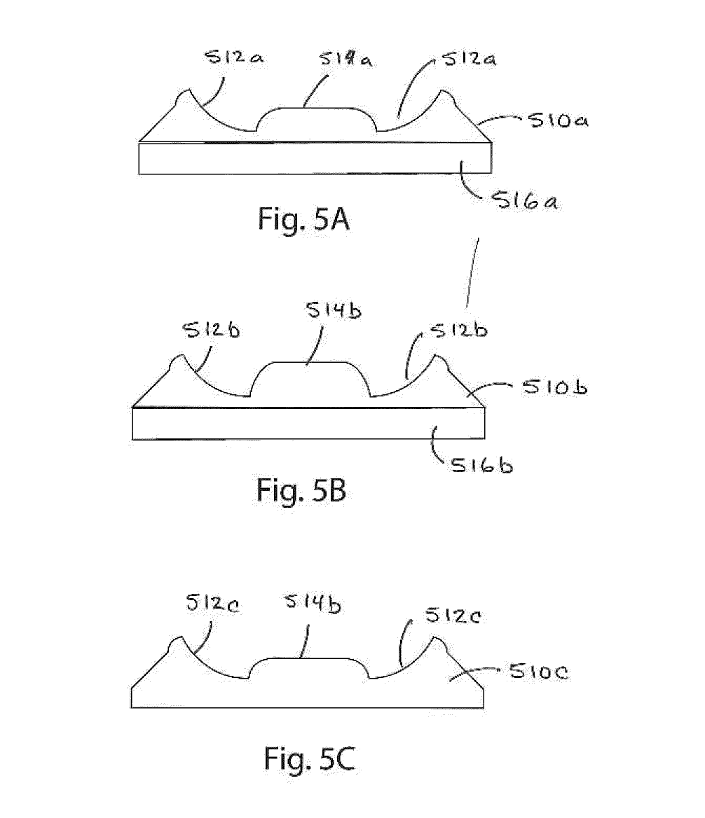

FIG. 5A shows a side cross sectional view of a base 510a made in accordance with a first implementation of the invention. The base 510a includes a curved interior surface 512a, which supports a balloon. The base 510a also includes a raised center portion 514a, which sticks up into the bottom of a balloon, limiting the amount of ice that forms at the bottom of the balloon, thereby promoting an unfrozen bottom. The base 510a sits on an insulator 516a.

FIG. 5B shows a side cross sectional view of a base 510b made in accordance with a first implementation of the invention. The base 510b includes a curved interior surface 512b, which supports and shapes a balloon. The base 510b also includes a raised center portion 514b, which sticks up into the bottom of a balloon, limiting the amount of ice that forms at the bottom of the balloon, thereby promoting an unfrozen bottom. The protrusion 514b is shown as being shorter than the protrusion 514a. It will be understood that various size protrusions can be created, or no protrusion at all. The base 510b sits on a insulator 516b.

FIG. 5C shows a side cross sectional view of a base 510c made in accordance with a first implementation of the invention, having a curved interior surface 512c. This base 510c includes an interior 520 that is filled with an insulating material, thereby eliminating the need for a separate insulator 516a or 516b.

As noted above, to keep the bottom of the ice globe from freezing, it can be appropriate to place the balloon and base on an insulating disk. The insulating disk keeps the bottom of the balloon from freezing as quickly and completely as other parts of the balloon, which maintains the bottom of the balloon in an open configuration that allows for placement on a stand and space for a candle or other source of illumination. In some implementations it is possible to use an insulated freezing base.

Generally it is necessary to check on the balloon occasionally to confirm it is freezing, but has not frozen solid. It is possible to check to see if a shell of ice is forming by firmly pushing on the balloon after about 14 to 18 hours for a small balloon, or 24 to 30 hours for a larger balloon. When a shell of ice forms, lift the balloon off the base and feel the unfrozen bottom. If the bottom is completely unfrozen, the globe will have thin walls. If the bottom is slushy and/or starting to freeze over, the result will be thicker walls on the ice globe. It is also possible to utilize a clear balloon to allow observation of the thickness of the globe walls during the freezing process.

If more thickness is desired, continue freezing and re-check occasionally, such as in 6-8 hours. Ice thickness varies with freezing time, volume of water and temperature. After a desired level of freezing, cut the balloon from the ice globe in a sink or outside where excess water can run out of the interior cavity which has formed. The ice globe is then separated from the base if it hasn't already come out of the base.

Next, typically a chimney hole is created in the top of the ice globe by placing it over a candle with plenty of air flow from underneath. In the alternative, a cordless drill can be used to create a chimney using the largest drill bit on hand. It is recommended that this option be completed by an adult wearing safety glasses. If the globe will be illuminated by an LED or similar light, a chimney hole is generally not necessary.

Finally, a candle is placed on a nonflammable surface and lit. The ice globe is placed over the candle with the chimney at the top. The bottom of the globe can be adjusted to allow for necessary air flow, including placing the ice globe on one of the display stands described herein.

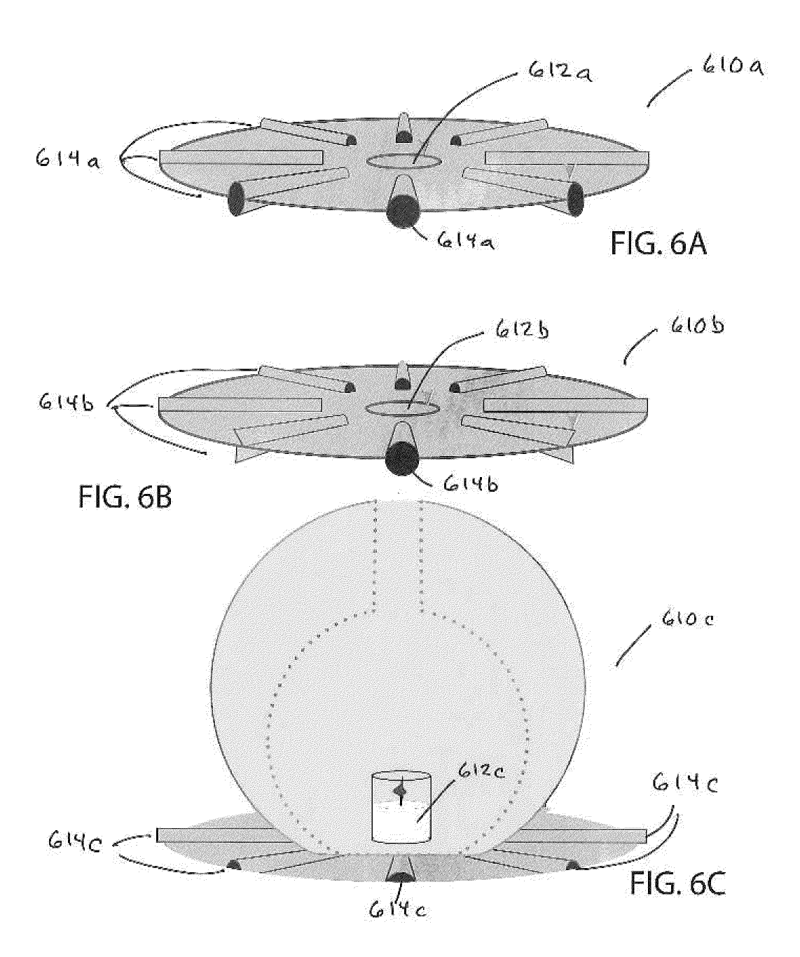

Reference will now be made to FIGS. 6A to 6C. FIG. 6A shows a first display stand 610a made in accordance with an implementation of the invention. The display stand 610a has a central circular portion 612a for holding a candle, plus a series of flutes 614a. The flutes 614a hold an ice globe up off the base, so that air can flow into the interior of the ice globe. The flutes 614a can also help to direct water away from the bottom of the globe. The base 610a can be positioned inside a bowl or on top of another vessel so as to capture and retain melting ice water from a globe placed upon it. The flutes 614a are round elements in this embodiment.

FIG. 6B shows a second display stand made in accordance with an implementation of the invention. The display stand 610b has a central circular portion 612b for holding a candle, plus a series of flutes 614b. The flutes 614b hold an ice globe up off the base, so that air can flow into the interior of the ice globe. The flutes 614a can also help to direct water away from the bottom of the globe. The base 610b can be positioned inside a bowl or on top of another vessel so as to capture and retain melting ice water from a globe placed upon it. The flutes 614a in this embodiment are a combination of round elements and flat vanes.

FIG. 6C shows a third display stand made in accordance with an implementation of the invention. The display stand 610c has a central circular portion 612c for holding a candle, plus a series of flutes 614c. The flutes 614c hold an ice globe up off the base, so that air can flow into the interior of the ice globe. The flutes 614c can also help to direct water away from the bottom of the globe. The base 610c can be positioned inside a bowl or on top of another vessel so as to capture and retain melting ice water from a globe placed upon it. The flutes 614c are shown as half-round elements in the embodiment of FIG. 6C.

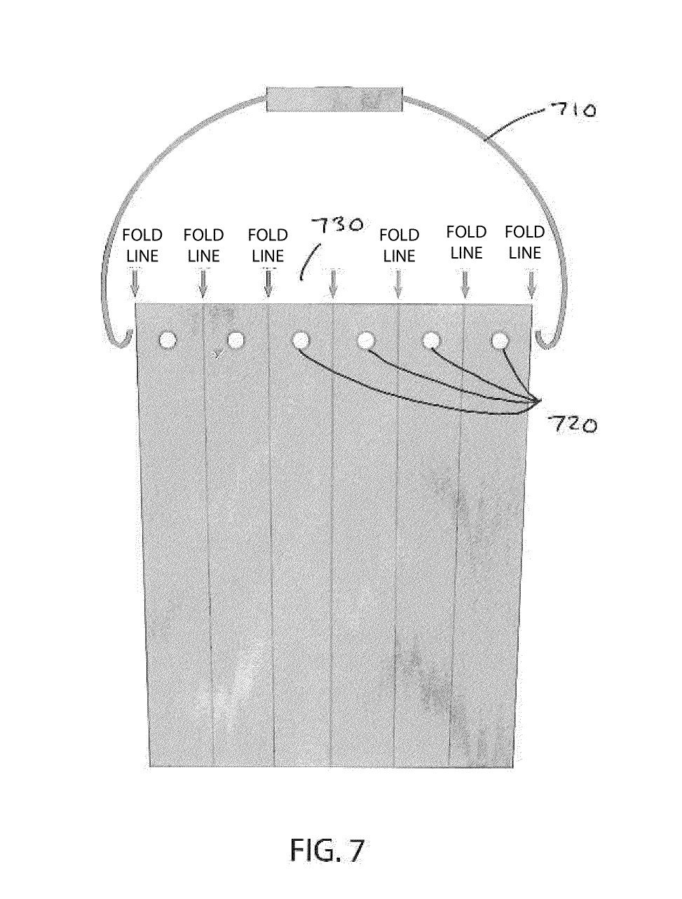

Alternative ice structures can also be created besides ice globes. For example, FIG. 7 shows a container for forming ice structures. In one example, a multi-sided ice lantern bucket 710 is use. The bucket 710 has a series of holes 720 around its top 730 allowing a cord to be strong through to make various shapes: pulling the cord through two opposite holes equals oblong lantern; pulling a cord through four opposite holes equals 4-pointed star lantern; pulling a cord through eight opposite holes equals an eight-pointed star lantern; etc.

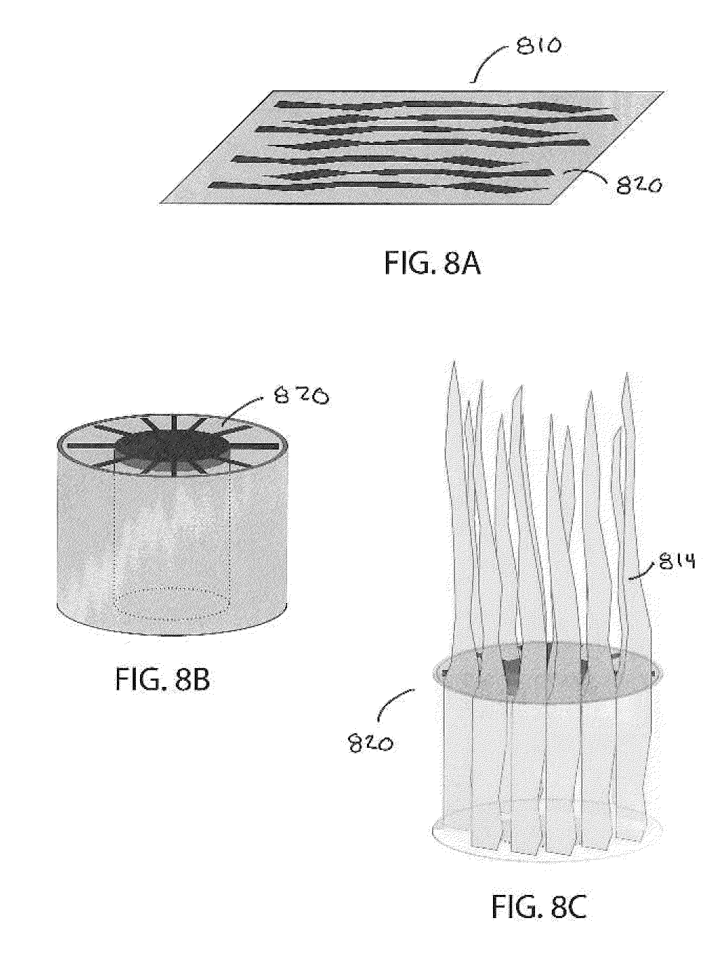

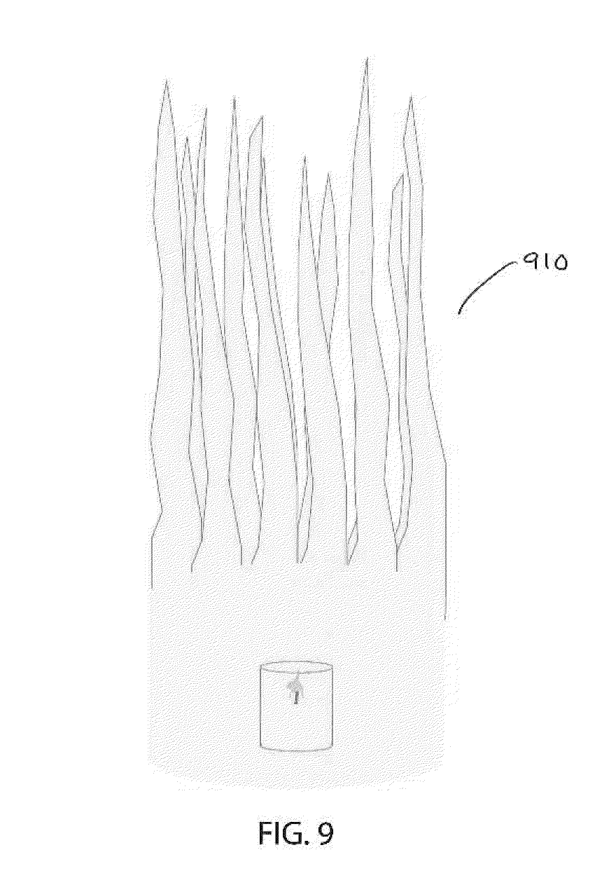

The invention is further directed to an icicle castle lantern. FIGS. 8A to 8C shows elements for making an ice castle lantern, and FIG. 9 shows an ice castle ice lantern. FIG. 8A shows a sheet 810 with a plurality of recesses 812 for forming long pieces of ice. FIG. 8B shows a mold 820 into which the ice pieces can be placed.

FIG. 8C shows the mold 820 with a plurality of ice pieces 814 positioned within the mold. After the ice pieces are placed in the mold 820, the mold can be filed with water and placed in a freezing environment. After freezing the mold is removed to reveal an ice castle 910 shown in FIG. 9.

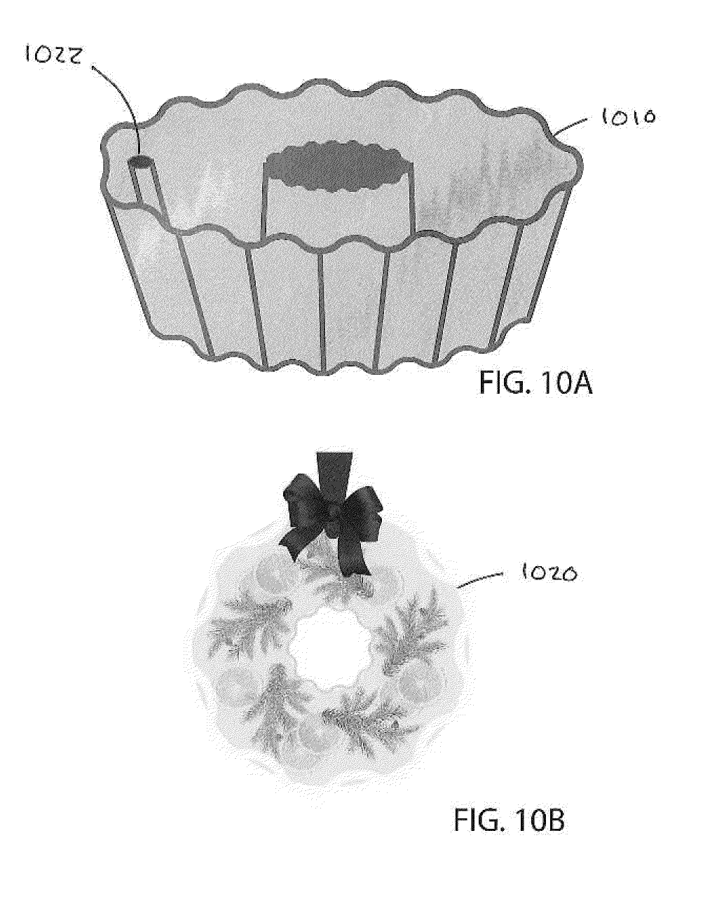

In another alternative implementation, an ice wreath is created. FIG. 10A shows an ice wreath mold 1010, and FIG. 10B shows an ice wreath 1020 made in accordance with the invention. The ice wreath 1120 is formed in the open mold 1110, such as one made of plastic, silicone, or metal. An extra tube 1112 comes from the bottom of the mold 1010 to make a hole 1022 to hang the finished ice wreath 1020. To use, just fill the mold 1010 with water plus any garnishes.

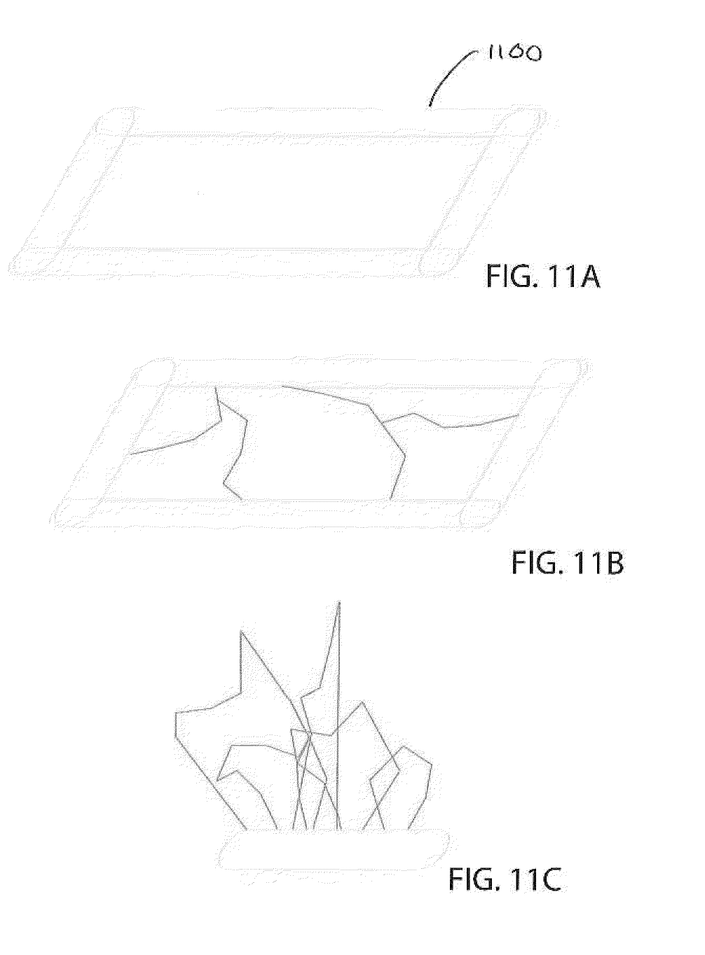

Yet another alternative embodiment is sheets of thin ice “glass” formed from for example, a thin sheet of ice made in a pan or flat plastic sheet. FIGS. 11A to 11C show an ice glass kit. Yet another alternative embodiment includes sheets of thin ice “glass” formed from, for example, a thin sheet of ice made in a pan or flat plastic sheet 1100. Pieces of the ice “glass” can be formed into an arrangement 1110 around a light source such as an ice lantern, a glass vase with candle, or LED lights.

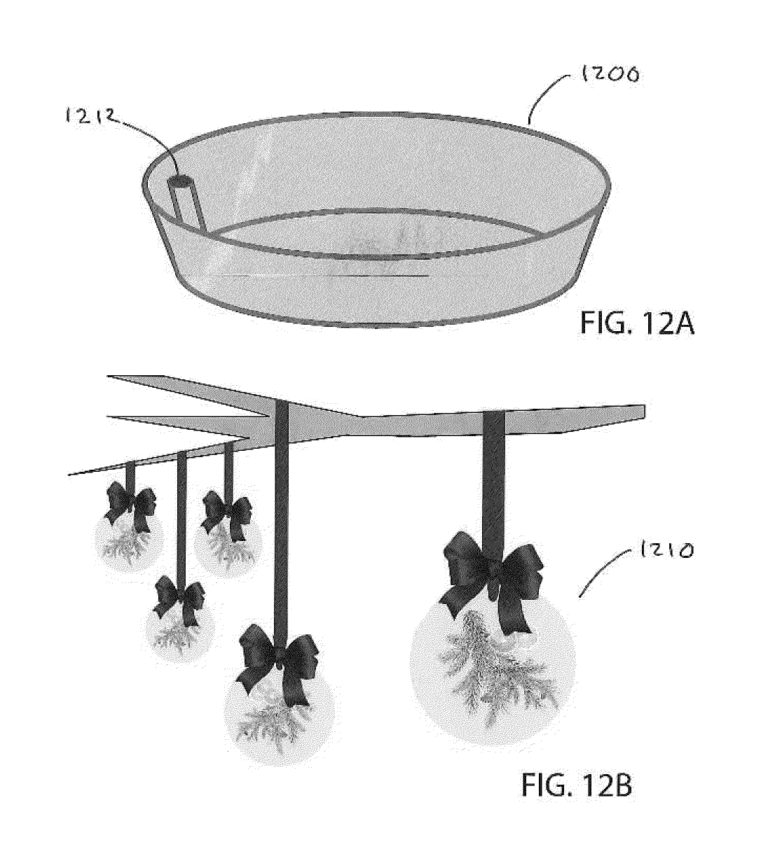

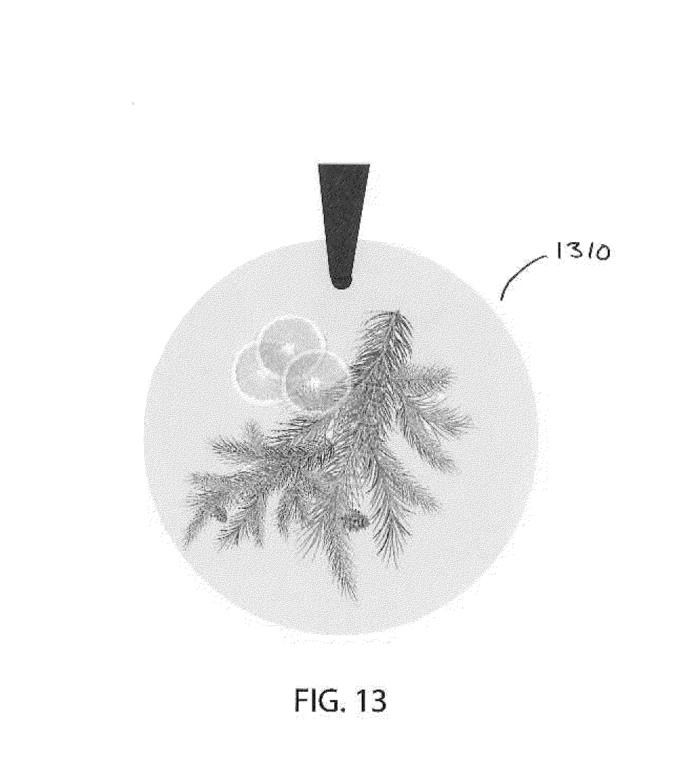

In an alternative embodiment of the invention, ice chimes are created. FIGS. 12A and 12B show an ice chime mold 1200 and ice chimes 1210, and FIG. 13 shows an ice chime 1310 made in accordance with an implementation of the invention. The ice chimes can be made in a plastic, silicone or metal mold (or other similar material). An extra tube 1212 comes from the bottom which makes a hole to hang ice chimes. It is possible to make the chimes in multiple sizes, such as three different sizes. To produce the chimes, fill the mold with water plus any garnishes. Freeze solid or let only top few inches freeze. Release from mold and hang from top hole. Arrange in trees so they clink or not.

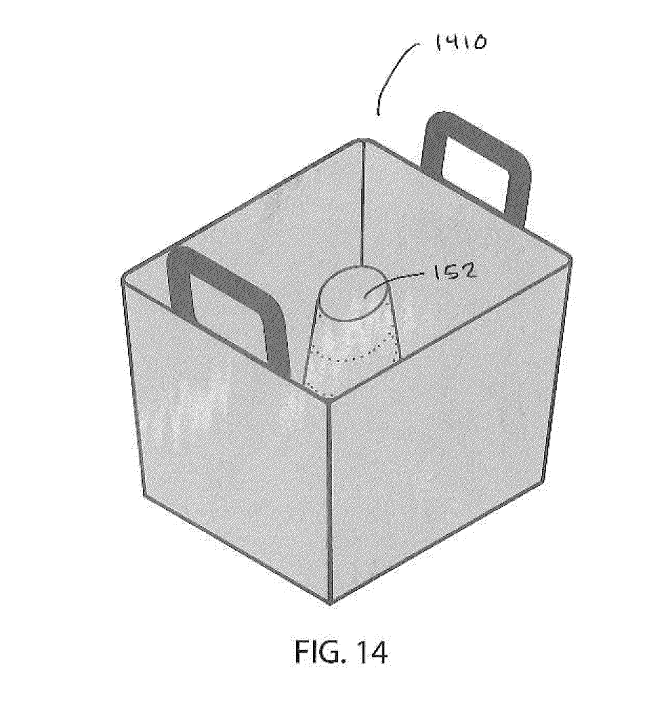

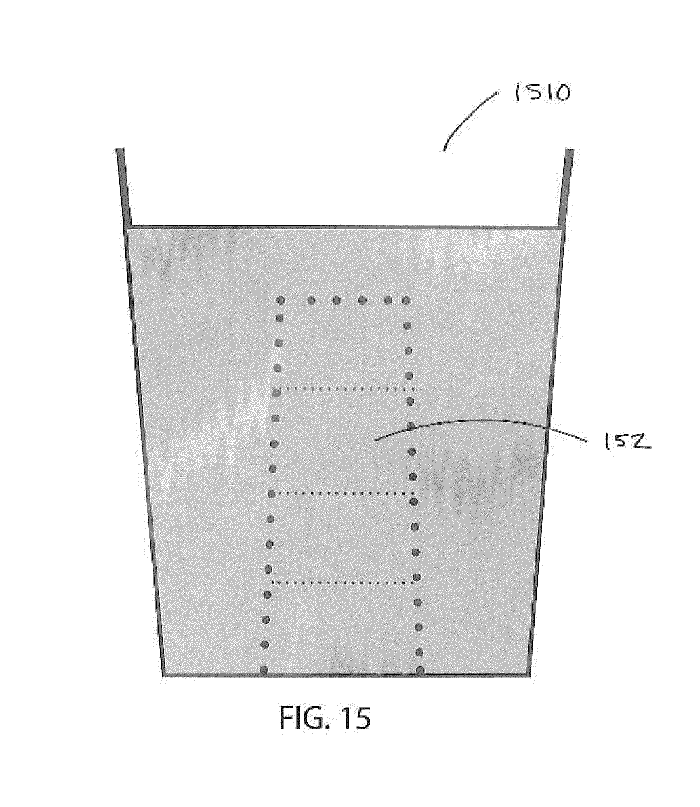

FIG. 14 shows an easy-release bucket ice lantern 1410. FIG. 15 shows an easy-release bucket 1510 for making an ice lantern, the bucket having a collapsible center tube 152. The easy-release ice lantern bucket can also be created using a multi-sided soft silicone bucket with handles. With the collapsible center tower down, the traditional method of allowing a shell of ice to form and then release is used. With the collapsible tower up, the user can allow the lantern to freeze solid and still be used because the ice lantern mold will easily peel off the ice structure.

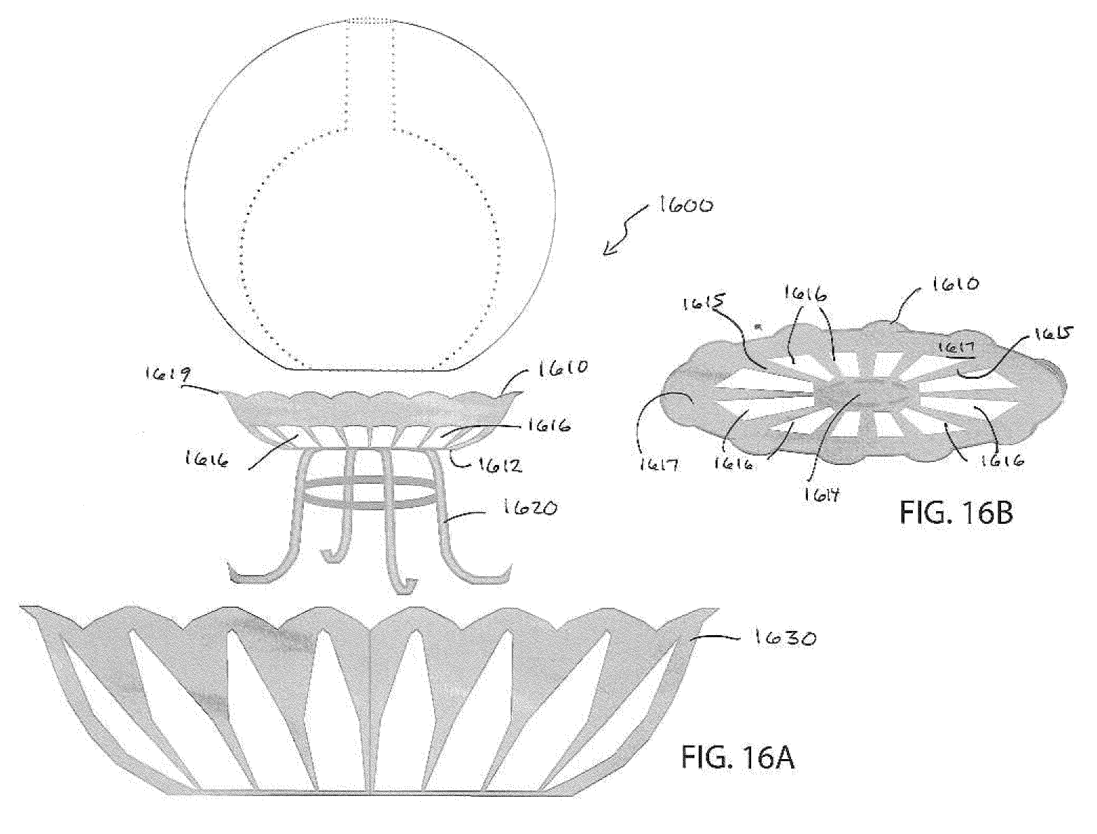

FIG. 16A shows an exploded view of centerpiece unit 1600. FIG. 16B shows centerpiece unit 1600. Centerpiece unit 1600 includes a top platform 1610, a riser 1620, and a bottom bowl 1630. Riser 1620 is secured to the bottom 1612 of the platform 1610. The riser 1620 is placed in a bowl 1630. The bowl 1630 should have sufficient volume to retaining a fully melted ice structure placed on the platform 1610. Optionally the platform 1610 comprises a central area 1614 for retaining a light source (not shown). In some implementations the central area 1614 for retaining a light source has a diameter of less than 3 inches. In certain embodiments the central area 1614 for retaining a light source has a diameter of greater than 2 inches. Typically the central area 1614 for retaining a light source has a diameter of from 2 to 3 inches. The central area 1614 for retaining a light source can have a depression for retaining the light source.

In certain embodiments the central area 1614 for retaining a light source is located at an elevation above surrounding area 1615. This allows for the central area 1614 to drain well, preventing a candle located at central area 1614 from getting excessively wet. Also, it will be understood that typically central area 1614 is free of any sort of protruding handle or grip that would prevent the placement of a light source at the center of the central area 1614.

In some embodiments the platform 1610 comprises a plurality of openings 1616 extending from a top surface 1617 to a bottom surface 1618, the plurality of openings 1616 allowing for water to pass through the platform 1610 and into the bowl 1630. Typically the plurality of openings 1616 account for at least 15 percent of the top surface 1617 of the platform 1610. Optionally the plurality of openings 1616 account for at least 25 percent of the top surface 1617 of the platform 1610. In some embodiments the plurality of openings 1616 comprise at least 35 percent of the top surface 1617 of the platform 1610. In the alternative, the plurality of openings 1616 comprises at least 50 percent of the top surface 1617 of the platform 1610.

Also, in some implementations the platform 1610 has a hole in the center so that a riser can extend through the hole, in which case the riser provides a central area for supporting a candle or other light source, and the platform 1610 can be positioned at various heights along the riser. The riser can be, for example, a cylinder, square, legs, etc. If hollow the riser will optionally have a hole in it to drain water that collects in the riser.

Often the platform 1610 comprises an upwardly facing perimeter lip 1619 for securing an ice structure. The platform 1610 can support an ice structure of at least 15 pounds in most embodiments, and optionally at least 25 pounds. In some implementations the platform 1610 and riser 1620 are integrally formed. Typically the platform has a diameter less than 75 percent of the diameter of the bowl 1630, alternatively the platform 1610 has a diameter less than 50 percent of the diameter of the bowl 1630.

In certain alternative embodiments the platform 1610 has a diameter equal to, or greater than, the diameter of the bowl 1630. In some implementations the platform 1610 has a diameter at least 10 percent greater than the diameter of the bowl 1630;

alternatively at least 20 percent greater than the diameter of the bowl 1630; alternatively at least 30 percent greater than the diameter of the bowl 1630; and alternatively at least 50 percent greater than the diameter of the bowl 1630. In embodiments where the platform 1610 has a diameter greater than the bowl 1630, the openings 1616 in the platform 1610 are still typically within the diameter of the bowl 1630. Thus, for example, if the platform 1610 is 10 inches in diameter, and the bowl 1630 is 8 inches in diameter, the openings 1616 in the platform will be within 4 inches of the center of the platform 1610 (so that water passing through the openings 1616 will still flow into bowl 1630. Note, that in some implementations an ice structure, such as an ice globe, can be wider than the bowl itself because melting water from the ice globe will typically flow along the side of the globe until it reaches the base of the globe.

The openings 1616 in platform 1610 typically comprise at least 10 percent of the total surface of the platform 1610, more commonly at least 20 percent, optionally at least 30 percent, alternatively at least 40 percent, and in some implementations at least 50 percent.

In some implementations the riser is adjustable in height, such as by having two telescoping portions that are threaded to one another, and can be lengthened and shorted by rotation relative to each other. Typically the riser has a height of four to eight inches; more typically three to ten inches. In most implementations the riser height is at least three inches, more typically at least 4 inches, and often at least 5 inches. Risers are frequently less than 12 inches, often less than 10 inches.

In an alternative embodiment the a platform sits directly on lip of a bowl, and no riser is used.

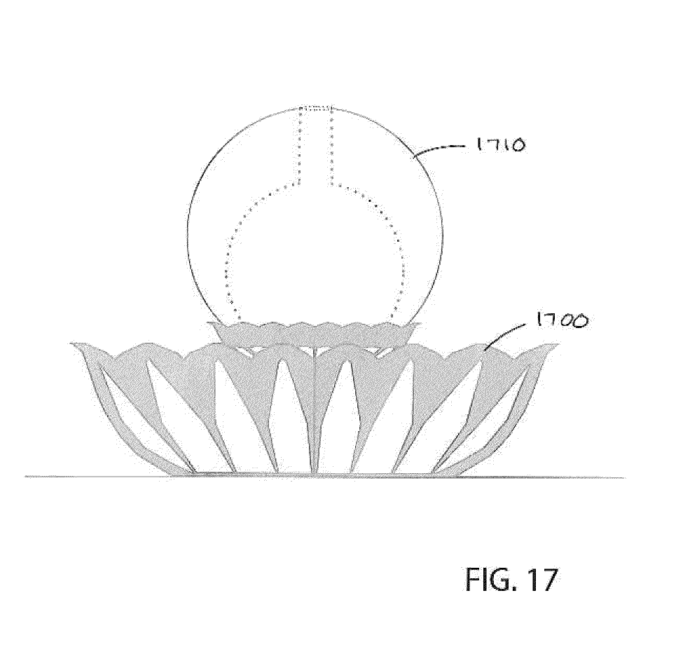

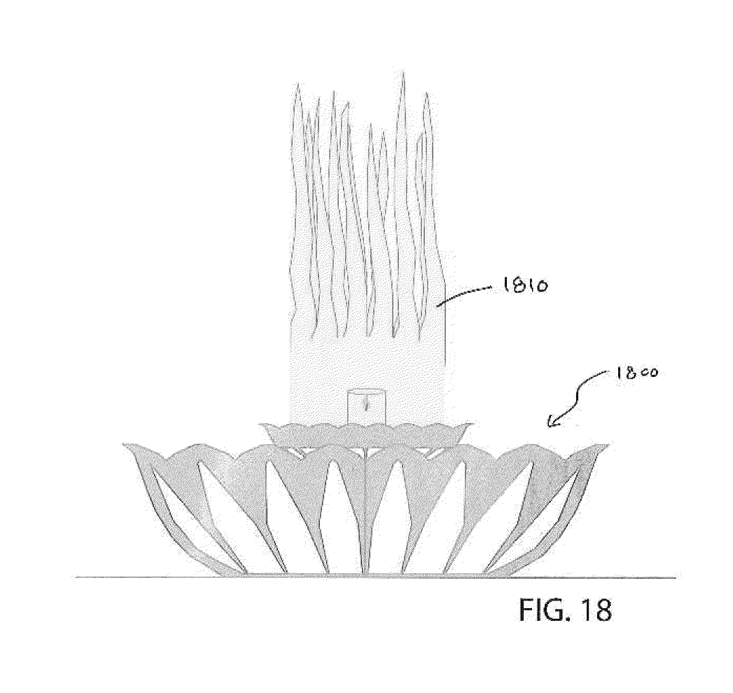

FIG. 17 shows an assembled centerpiece unit 1700 with a globe ice lantern 1710; and FIG. 18 shows a centerpiece unit 1800 with an icicle castle lantern 1810. In some implementations the centerpiece unit includes a structured metal riser with cupped top that has ventilation and drainage to be topped with a globe ice lantern, icicle castle lantern or large candle. There is a raised center ring (with one or more gaps to allow water to flow away from candleholder) to hold candle or other light source (in a candleholder) in place but not fill with water. Legs 1620 can have rubber bottoms to keep it in place in a bowl/surface. Riser will sit in decorative bowl (polycarbonate or other material) that has a capacity of approximately 2 gallons (in some implementations) to catch melting ice.

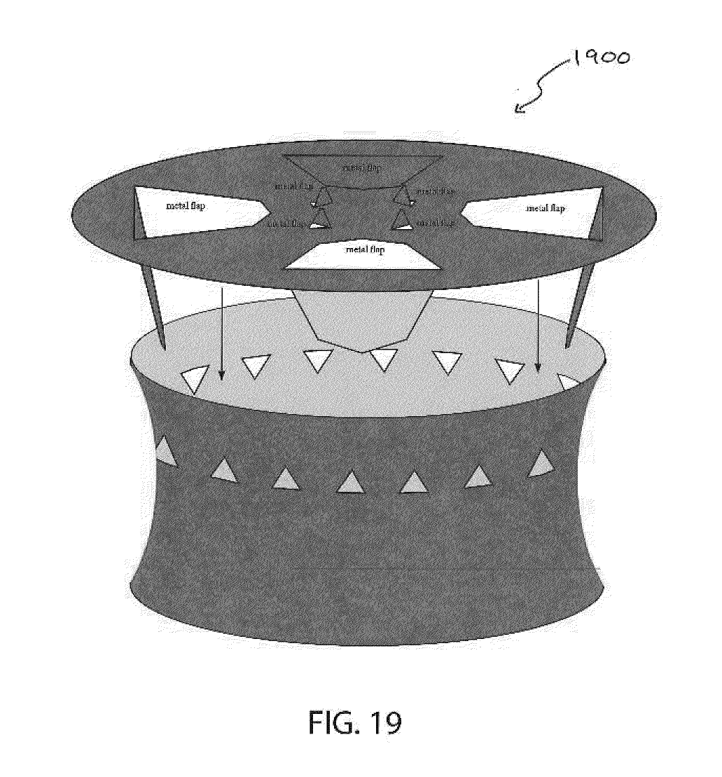

FIG. 19 shows a chimney creator and alternative display pedestal 1900. An ice globe sits on top of the metal disc structure (made, for example, of aluminum or aluminum alloy) with candle in to carve a chimney. Air flaps crated by meal flaps allow the candle to breath. Center flaps fold up to create a place for the candle to sit as well as more air holes to feed the candle for smaller ice globes. The aluminum structure can be placed in a bowl for display, and combined with trimmings to decorate.

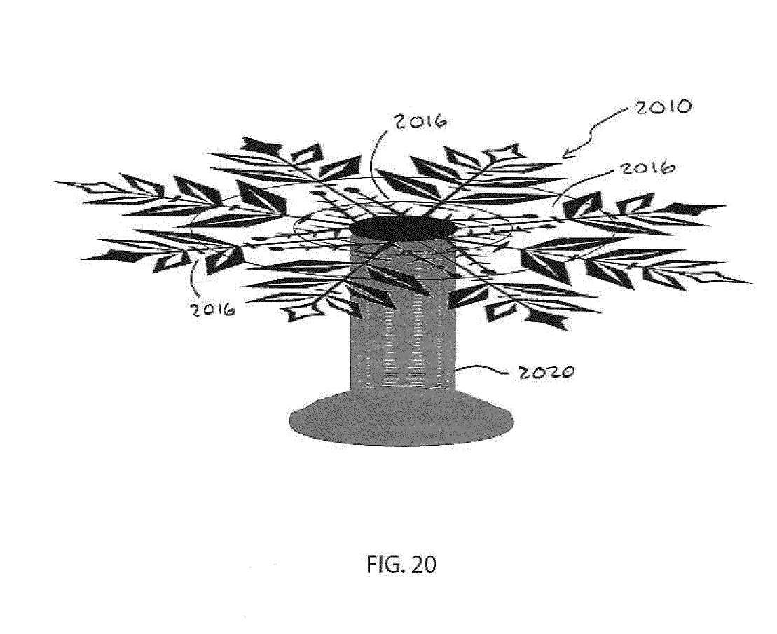

FIG. 20 shows an alternative platform 2010 and riser 2020 made in accordance with an implementation of the invention. The platform 2010 includes a central portion 2014 for retaining a candle, plus a plurality of open areas 2016 allow for air to enter the bottom of an ice structure. The platform 2010 and riser 2020 are shown displayed outside of a bottom bowl, although in use they are typically combined with a bottom bowl.

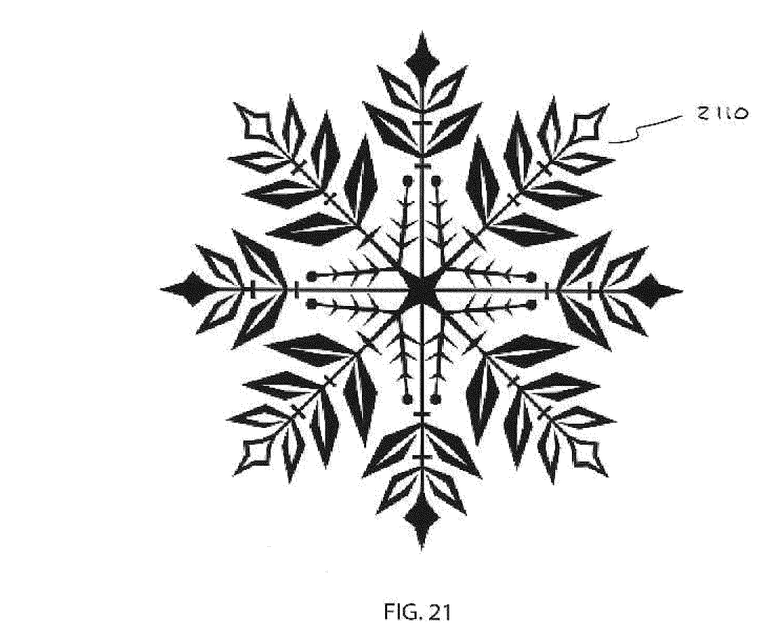

FIG. 21 shows a top view of a platform 2110 made in accordance with an implementation of the invention. The platform allows for placement of an ice structure in particular an ice globe, onto it, and allows for melted water to drain away while allowing air to enter the bottom of the ice structure (such as the location of a candle).

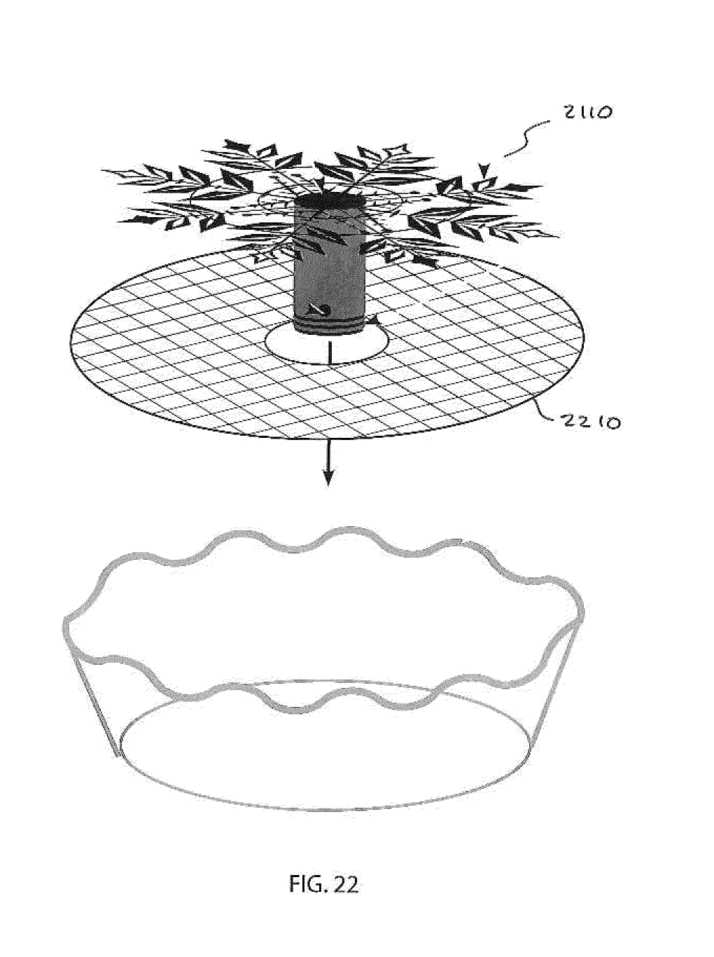

FIG. 22 shows an exploded view of a display assembly made in accordance with an implementation of the invention, the display assembly including an intermediate platform 2210 for arranging decorative elements such as vines, pine boughs, or flower stems. The intermediate platform 2210 will generally be a mesh or other material with a large number of holes. For example, the mesh can be at least 50 percent open, alternatively at least 75 percent open, and alternatively at least 90 percent open. The mesh should be positioned above the bottom of the bowl in which it is positioned, typically at least a half inch above the bottom of the bowl, commonly at least an inch above the bottom of the bowl, optionally at least 2 inches above the bottom of the bowl.

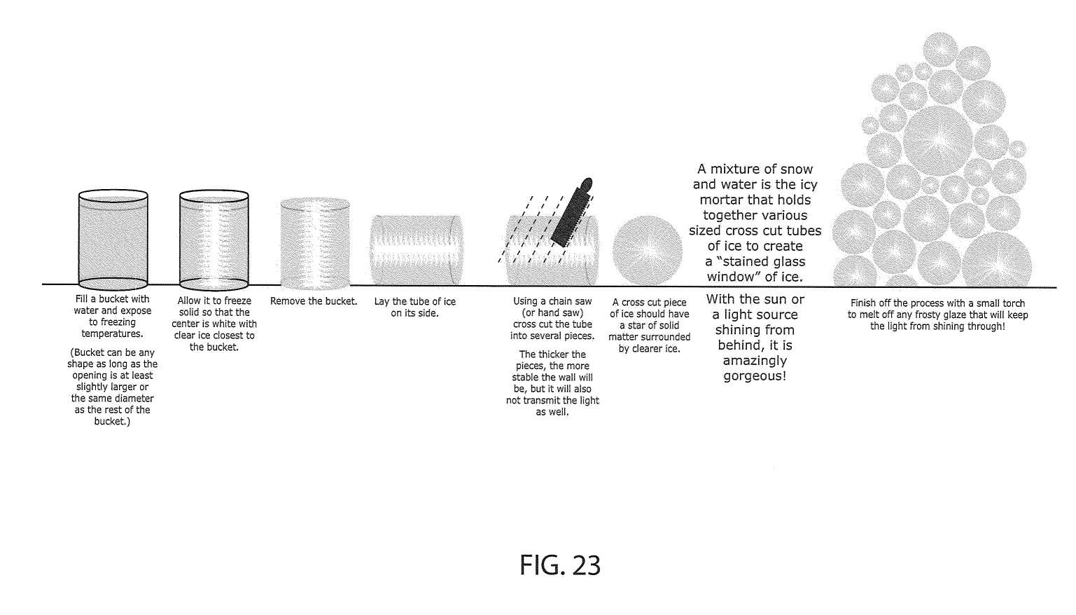

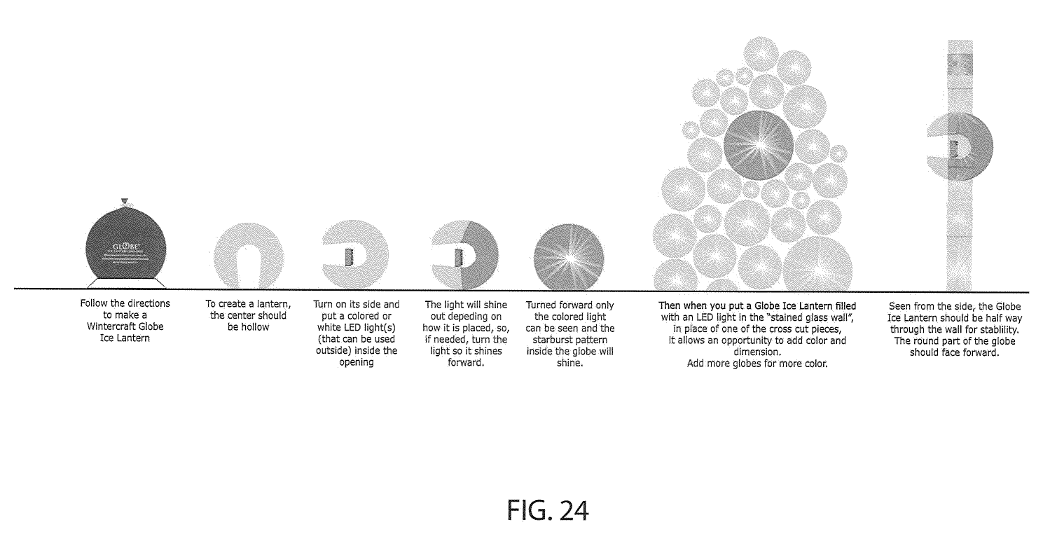

FIG. 23 shows a first process for making an ice structure wall. FIG. 24 shows a second process for making an ice structure wall.

The riser and platform allow for simultaneous air flow from beneath the platform while the bowl beneath the riser and platform allows for accumulation of slowly melting water

We claim:

1. An ice structure display stand, the stand comprising:
a) a platform configured to retain an ice structure;
b) a riser, the riser secured to the bottom of the platform :
c) a bowl, the bowl retaining the riser.

2. The ice structure display stand of claim 1, wherein the platform comprises a central area for retaining a light source.

3. The ice structure display stand of claim 2, wherein central area for retaining a light source has a diameter of less than 3 inches.

4. The ice structure display stand of claim 2, wherein central area for retaining a light source has a diameter of greater than 2 inches.

5. The ice structure display stand of claim 2, wherein central area for retaining a light source has a diameter of from 2 to 3 inches.

6. The ice structure display stand of claim 2, wherein central area for retaining a light source has a depression for retaining the light source.

7. The ice structure display stand of claim 1, wherein the platform comprises a plurality of openings extending from a top surface to a bottom surface, the plurality of openings allowing for water to pass through the platform and into the bowl.

8. The ice structure display stand of claim 1, wherein the platform comprises a plurality of openings extending from a top surface to a bottom surface, the plurality of openings accounting for at least 15 percent of the top surface of the platform.

9. The ice structure display stand of claim 1, wherein the platform comprises a plurality of openings extending from a top surface to a bottom surface, the plurality of openings accounting for at least 15 percent of the top surface of the platform.

10. The ice structure display stand of claim 1, wherein the platform comprises a plurality of openings extending from a top surface to a bottom surface, the plurality of openings accounting for at least 35 percent of the top surface of the platform.

11. The ice structure display stand of claim 1, wherein the platform comprises a plurality of openings extending from a top surface to a bottom surface, the plurality of openings accounting for at least 50 percent of the top surface of the platform.

12. The ice structure display stand of claim 1, wherein platform is formed of metal.

13. The ice structure display stand of claim 1, wherein platform comprises an upwardly facing perimeter lip for securing an ice structure.

14. The ice structure display stand of claim 1, wherein the platform can support an ice structure of at least 15 pounds.

15. The ice structure display stand of claim 1, wherein the platform can support an ice structure of at least 25 pounds.

16. The ice structure display stand of claim 1, wherein platform and riser are integrally formed.

17. The ice structure display stand of claim 1, wherein the platform has a diameter less than 90 percent of the diameter of the bowl.

18. The ice structure display stand of claim 1, wherein the platform has a diameter less than 50 percent of the diameter of the bowl.

19. The ice structure display stand of claim 1, further comprising an mesh intermediate the platform and bowl, the mesh configured for retaining decorative elements.

20. An ice structure display stand, the stand comprising:
a) a top platform configured to retain an ice structure, the platform comprising a recessed central area, an upwardly turned perimeter lip, and a plurality of openings through the platform intermediate the recessed central area and the upwardly turned perimeter lip;
b) a riser, the riser secured to the underside of the top platform and comprising a top surface configured to engage a bottom surface of the top platform;
c) a bowl, the bowl retaining the riser, wherein the bowl has a diameter at least 25 percent greater than the diameter of the top platform; and
d) an intermediate platform located between the top platform and the bowl, the intermediate platform substantially surrounding the riser and having an external diameter greater than the platform but less than the bowl, wherein the platform has a plurality of holes of at least 0.5 inches in diameter covering at least 50 percent of the top platform.
